(19) United States
(12) Patent Application Publication
(10) Pub. No.: US 2007/0043564 A1
(43) Pub. Date: Feb. 22, 2007

(54) Parameterization of counting systems

(75) Inventors: Anatoliy Burukhin, Issaquah, WA (US); Ayman M. Aldahleh, Redmond, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/207,210

(22) Filed: Aug. 19, 2005

(51) Int. Cl. G10L 15/06

(52) U.S. Cl. 704/245

(57) ABSTRACT

A system and method for storing and retrieving the written or spoken equivalents for numbers. In order to handle different representation of numbers, including spoken or written representations, the recurring patterns are expressed based on the radix of the system using sub-patterns. The patterns may be indexed to a vocabulary of text strings, then used to generate the text equivalent of any number within the range of the pattern. A database may store the patterns and vocabularies for one or many different languages. Such a system captures the complexities and exceptions in the spoken tongue while keeping the size of the database, even for large numbers of languages, in a very compact size.

### BACKGROUND

a. Technical Field

The present invention pertains generally to data processing systems and specifically to translation of numbers into written language equivalents.

b. Description of the Background

In many computer programs, numbers must be converted into written or spoken language equivalents. For example, the number 14 may need to be expressed as “fourteen”, or the number 123 may be expressed as “one hundred twenty-three.” In some languages such as French, the number 87 may be expressed in the equivalent of “four score and seven.”

Translating from a number to the spoken equivalent of that number is difficult to express in a simple pattern. While the expressions ‘two’ may be used in different situations, such as ‘twenty-two’ and ‘thirty-two’, the pattern fails at ‘twelve’. Because of this and other anomalies in the patterns of number expressions, some solutions have involved creating a large array of text strings, one for each expression of a number within a certain range, typically from 0 to 999,999. This obviously results in a database having 1,000,000 separate text strings. As more and more languages are supported, the size of such databases can become enormous.

It would therefore be advantageous to provide a system and method for handling spoken or written expressions of numbers in a more compact manner.

### SUMMARY

In order to handle different representation of numbers, including spoken or written representations, the recurring patterns are expressed based on the radix of the system using sub-patterns. The patterns may be indexed to a vocabulary of text strings, then used to generate the text equivalent of any number within the range of the pattern. A database may store the patterns and vocabularies for one or many different languages.

Such a system captures the complexities and exceptions in the spoken tongue while keeping the size of the database, even for large numbers of languages, in a very compact size.

### BRIEF DESCRIPTION OF THE DRAWINGS

In the drawings,

FIG. 1 is a diagrammatic illustration of an embodiment showing a system for expressing numbers in written or spoken form.

FIG. 2 is a flowchart illustration of an embodiment showing a method for creating a parameterized number representation database.

FIG. 3 is a flowchart illustration of an embodiment showing a method for generating a written or spoken representation of a number using the parameterized database.

### DETAILED DESCRIPTION

While the invention is susceptible to various modifications and alternative forms, specific embodiments of the invention are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. In general, the embodiments were selected to highlight specific inventive aspects or features of the invention.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The invention may be embodied as devices, systems, methods, and/or computer program products. Accordingly, some or all of the invention may be embodied in hardware and/or in software (including firmware, resident software, micro-code, state machines, gate arrays, etc.) Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the invention is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

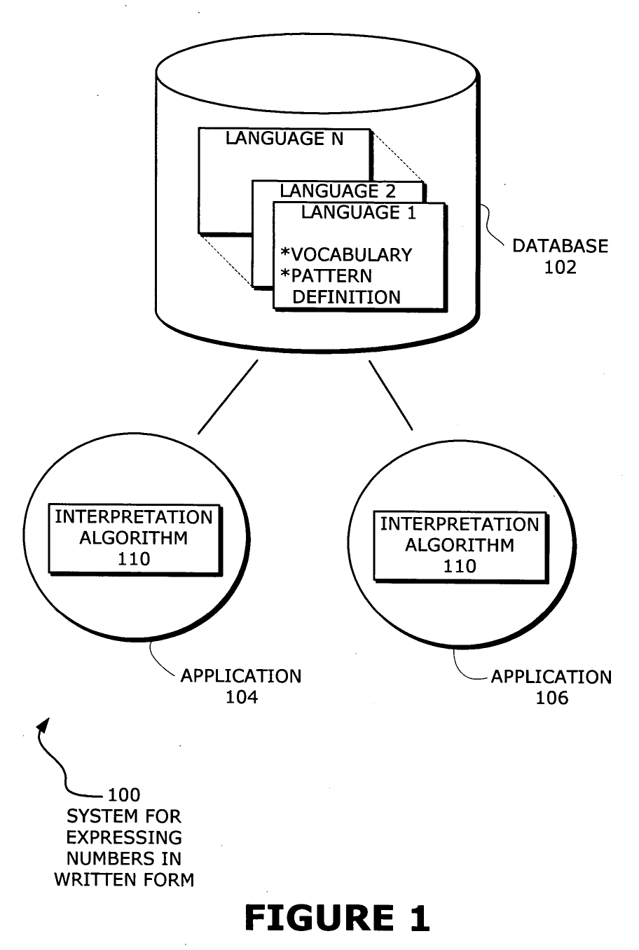

FIG. 1 illustrates an embodiment 100 showing a system for expressing numbers in written form. A database 102 is accessed by computer applications 104 and 106. Within the database 102, are the language definitions 108 for several languages. Each application 104 and 106 comprises an interpretation algorithm 110 that can query the database 102 and determine the written or spoken form of a number for a specific language.

The embodiment 100 illustrates a system by which the written or spoken expressions of numbers are captured in a database 102 for one or many languages. The languages are captured in a vocabulary and pattern definitions. Since the written or spoken representations of a number generally have a limited vocabulary which is used in patterns, those patterns are stored with the vocabulary in the database. The interpretation algorithm 110 can interpret the patterns for a particular number, and generate the written or spoken representation of the number.

The vocabulary used in the database 102 may be either a written, textual vocabulary, or an audio vocabulary. In the written form, the vocabulary may comprise a series of text strings that are built into a longer sequence of strings to define the number. In an audio form, a series of audio files or clips may be joined together into a sequence representing the spoken number.

The language representations 108 may comprise many different languages. As support for a new language may be required, the peculiarities of the new language may be captured into the pattern definitions, and the database 102 may be updated for the new language support. Because the unique qualities of the individual languages can be captured in the database 102, the application 104 or 106 may not require any modification for the new language support. Such a system may benefit application developers whose applications are used in many different cultures and countries, as the database 102 may be much more compact and manageable than would be separate text strings or audio files for every number from 0 to 999,999, for example.

The system of embodiment 100 allows different and diverse applications 104 and 106 to access a common database 102. By sharing the database 102 between different applications, the language support for many different applications may be managed through a single point, and the various applications may have a unified functionality. Additionally, new applications may use the database 102 without having to re-create the same functionality. In some situations, the use of the database 102 and the interpretation algorithm 110 may lead to a unified look and feel to the various applications.

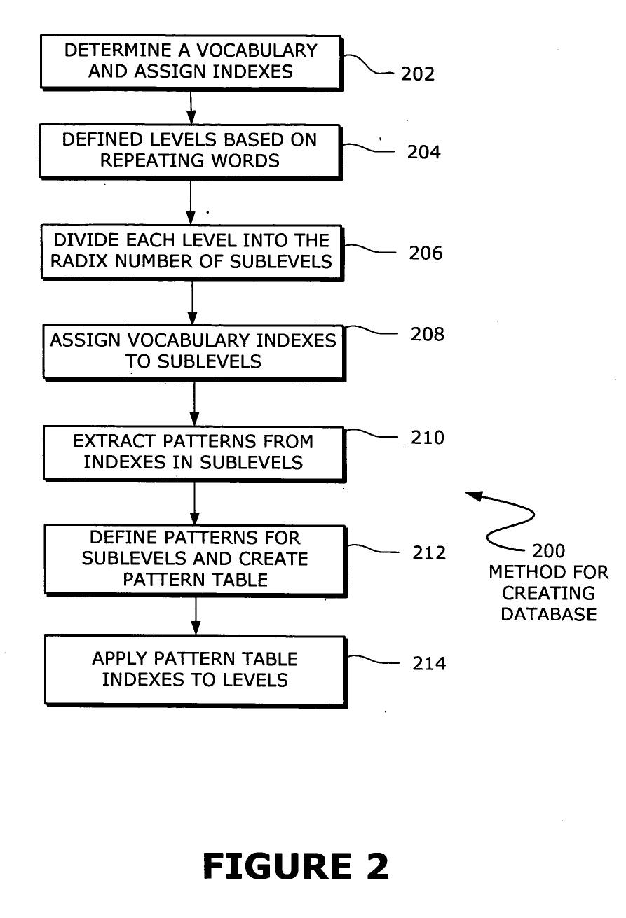

FIG. 2 is a flowchart illustration of an embodiment 200 showing a method for creating a language representation database. A vocabulary is defined and indexed in block 202. The repeating characteristics of the language are used to define levels in block 204. Each level is divided into sublevels based on the radix in block 206. The vocabulary indexes are assigned to the sublevels in block 208, and patterns are extracted from the indexes in block 210. The patterns found within the sublevels are defined in block 212 and applied to the levels in block 214.

The embodiment 200 is a general method whereby the recurring patterns of a spoken or written representation of numbers can be captured and stored in a group of recurring patterns. In some cases, recurring patterns and their exceptions may be represented. The embodiment 200 may be applied to any language, however, English will be used in the following example.

In the following example, the patterns and representations for the English written language are developed for the numbers 1 to 99. Counting from 1 to 99 involves recurring patterns, such as “one”, “two”, and “three” that recurs in “twenty-one”, “twenty-two”, and “twenty-three” and so on. However, the pattern is different for the numbers from 11 to 19, where the representation is “eleven”, “twelve”, and “thirteen”. Further, in some cases a hyphen (“-”) may be placed after the word “twenty” in the combination “twenty-one” but not when the word “twenty” is used alone. These peculiarities will be illustrated in the following example.

In block 202, the vocabulary is established. For the example, the vocabulary may be represented as Table 1.

TABLE 1
Vocabulary and Index

| Word | Index |
|---|---|
| “” | 0 |
| “one” | 1 |
| “two” | 2 |
| “three” | 3 |
| “four” | 4 |
| “five” | 5 |
| “six” | 6 |
| “seven” | 7 |
| “eight” | 8 |
| “nine” | 9 |
| “ten” | 10 |
| “eleven” | 11 |
| “twelve” | 12 |
| “thirteen” | 13 |
| “fourteen” | 14 |
| “fifteen” | 15 |
| “sixteen” | 16 |
| “seventeen” | 17 |
| “eighteen” | 18 |
| “nineteen” | 19 |
| “—” | 20 |
| “twenty” | 21 |
| “thirty” | 22 |
| “forty” | 23 |
| “fifty” | 24 |
| “sixty” | 25 |
| “seventy” | 26 |
| “eighty” | 27 |
| “ninety” | 28 |

Table 1 contains the various text strings that will be used to represent the numbers between 1 and 99. Even though 99 different text strings may be generated, only 28 actual text strings are defined in the database. In this example, the size of the text database is a small fraction of the total number of text strings which can be represented by the database. Even more substantial size savings can be realized if the example were to be expanded to capture larger numbers, such as hundreds, thousands, millions, etc.

Each text string has been assigned an index. In Table 1, each index number is sequentially assigned to sequential text strings. However, the index is merely a unique identifier and can be any randomly assigned number, most commonly an integer.

The words are spread out into levels based on the repeating words in block 204. Table 2 illustrates one embodiment using the current example.

TABLE 2
Defining Levels Based on Repeating Words

| | Level 3 | Level 2 | Level 1 |
|---|---|---|---|
| 0 | | | “” |
| 1 | | | “one” |
| 2 | | | “two” |
| . . . | | | |
| 98 | “ninety” | — | “eight” |
| 99 | “ninety” | — | “nine” |

In Table 2, three levels are defined. Level 3 contains most of the tens representations. Level 2 contains a separator text string, in this case a hyphen, and Level 1 contains the ones representation. Level 1 also contains all of the representation of the numbers between 11 and 19. Level 3 contains the tens representations for twenty through ninety, but not for ten through nineteen.

Table 3 illustrates the contents of Table 2, grouped by the radix of 10.

TABLE 3
Grouping of Level 1 Words by Radix

| | | | 20 | 30 | 40 | 50 | 60 | |
|---|---|---|---|---|---|---|---|---|
| Sublevel | 0 | 10 | Twenty | Thirty | Forty | Fifty | Sixty | . . . |
| 0 | “ ” | “ten” | “ ” | “ ” | “ ” | “ ” | “ ” | |
| 1 | “one” | “eleven” | “one” | “one” | “one” | “one” | “one” | |
| 2 | “two” | “twelve” | “two” | “two” | “two” | “two” | “two” | |
| . . . | | | | | | | | |
| 9 | “nine” | “nineteen” | “nine” | “nine” | “nine” | “nine” | “nine” | |

Replacing every word in Table 3 with the index from Table 1 yields Table 4.

TABLE 4
Grouping of Level 1 Indexes by Sublevels

| | | | 20 | 30 | 40 | 50 | 60 | |
|---|---|---|---|---|---|---|---|---|
| Sublevel | 0 | 10 | Twenty | Thirty | Forty | Fifty | Sixty | . . . |
| 0 | 0 | 10 | 0 | 0 | 0 | 0 | 0 | |
| 1 | 1 | 11 | 1 | 1 | 1 | 1 | 1 | |
| 2 | 2 | 12 | 2 | 2 | 2 | 2 | 2 | |
| . . . | | | | | | | | |
| 9 | 9 | 19 | 9 | 9 | 9 | 9 | 9 | |

Table 4 illustrates the recurring patterns of the spoken numbers between one and 99. The indexes of Table 1 were selected so that the index of the string “ten” is index 10, “eleven” is index 11, and so on.

Table 4 can be further consolidated by defining a sublevel dictionary for each row, and defining indexes to the sublevel dictionary. This is shown in Table 5.

TABLE 5
Sublevel Dictionary Assignments

| | Dictionary | | | | | | | |
|---|---|---|---|---|---|---|---|---|
| | (vocabulary | | | | | | | |
| Sublevel | indexes) | 0 | 10 | 20 | 30 | 50 | 60 | . . . |
| 0 | 0, 10 | 0 | 1 | 0 | 0 | 0 | 0 | |
| 1 | 1, 11 | 0 | 1 | 0 | 0 | 0 | 0 | |
| 2 | 2, 12 | 0 | 1 | 0 | 0 | 0 | 0 | |
| . . . | | | | | | | | |
| 9 | 9, 19 | 0 | 1 | 0 | 0 | 0 | 0 | |

The second column of Table 5 is the sublevel dictionary, which point to the proper index within Table 1 for the vocabulary string. The remaining columns contain indexes into the sublevel dictionary, with the index 0 referring to the first item of the sublevel dictionary of column 2, and 1 referring to the second item.

For example, the 0 located in the “forty” column and “2” row refers to the first index of the sublevel dictionary, which is 2. Index 2 in the sublevel dictionary refers to the text string “two”. Similarly, the 1 located in the “ten” column and “2” row refers to the second index of the sublevel dictionary, which is 12. Index 12 in the sublevel dictionary refers to the text string “twelve”.

The rows of Table 5 may be defined by a recurring pattern. In every row of Table 5, the pattern is “0,1,0,0,0,0,0,0,0,0”. The number of entries in this pattern is equal to the radix. For a shorthand notation, the pattern “0,1,0,0,0,0,0,0,0,0” may be represented by “0,1,0*8”, where “0*8” represents eight “0” entries in the series. Table 6 shows a table of patterns.

TABLE 6
Patterns

| | Pattern | | |
|---|---|---|---|
| Pattern | (short form) | Pattern Cycle | Index |
| 0, 1, 0, 0, 0, 0, 0, 0, 0, 0 | 0, 1, 0 * 8 | 10 | 0 |
| | | (the pattern has 10 | |
| | | elements) | |
| 0 | 0 | 1 | 1 |
| 0, 0, 1, 1, 1, 1, 1, 1, 1, 1 | 0 * 2, 1 * 8 | 10 | 2 |

Table 6 illustrates three patterns used in the representation of the numbers 1 to 99. Pattern index 0, or “0,1,0,0,0,0,0,0,0,0” is used to denote the pattern of the rows of Table 4. Pattern index 1, or “0,0,0,0,0,0,0,0,0,0” is used to denote a pattern when a word is used every time during the pattern cycle. Pattern index 2, or “0,0,1,1,1,1,1,1,1,1” is used to denote a pattern when a first index is used for the first two cycles, and the second index is used for the remaining cycles.

Table 7 illustrates the uses of the three patterns in the example.

TABLE 7
Consolidated Data

| | | | | Pattern to |
|---|---|---|---|---|
| | | | | vocabulary |
| | | | | index with |
| | Word | | Pattern (from | respect to |
| Level | recurrence | Sublevel | table 6) | pattern |
| 1 | 1 | 0 | 0 | 0, 10 |
| | | 1 | 0 | 1, 11 |
| | | 2 | 0 | 2, 12 |
| | | 3 | 0 | 3, 13 |
| | | 4 | 0 | 4, 14 |
| | | 5 | 0 | 5, 15 |
| | | 6 | 0 | 6, 16 |
| | | 7 | 0 | 7, 17 |
| | | 8 | 0 | 8, 18 |
| | | 9 | 0 | 9, 19 |
| 2 | 1 | 0 | 1 | 0 |
| | | 1 | 2 | 0, 20 |
| | | 2 | 2 | 0, 20 |
| | | 3 | 2 | 0, 20 |
| | | 4 | 2 | 0, 20 |
| | | 5 | 2 | 0, 20 |
| | | 6 | 2 | 0, 20 |
| | | 7 | 2 | 0, 20 |
| | | 8 | 2 | 0, 20 |
| | | 9 | 2 | 0, 20 |
| 3 | 10 | 0 | 1 | 0 |
| | | 1 | 1 | 0 |
| | | 2 | 1 | 21 |
| | | 3 | 1 | 22 |
| | | 4 | 1 | 23 |
| | | 5 | 1 | 24 |
| | | 6 | 1 | 25 |
| | | 7 | 1 | 26 |
| | | 8 | 1 | 28 |
| | | 9 | 1 | 29 |

Table 7 consolidates all the data for the three levels of the example. Level 1, in the first third of Table 7, represents the patterns needed to display the representation of the ones digit of a number. Level 2, in the middle third of Table 7, represents the patterns needed to display the hyphen between the tens and ones digits, if any. Level 3, in the bottom third of Table 7, represents the patterns needed to display the tens digit of any number between 1 and 99.

Table 7 is one embodiment of the recursive patterns that may be used to determine the spoken or written representation of a number between 1 and 99. Two layers of recursive patterns are used to define the sequence of counting in the spoken or written English language. Within each pattern may be one or more exceptions to the pattern, which may be defined by the alternative indexes such as in pattern index 0. The recognition and definition of such patterns allows the complex spoken or written representation of numbers to be consolidated into three tables, namely Table 1, the vocabulary, Table 6, the table of patterns, and Table 7, the consolidated data. In some embodiments, the data from Table 6 and Table 7 may be consolidated, so that the patterns of Table 6 are stored in the fourth column of Table 7.

Various layouts, notations, and indicia may be used by those skilled in the art to store the representations numbers in spoken or written languages. The examples and embodiments illustrated in this specification have been chosen to illustrate the concept of defining recurring patterns on several levels, with each level having a number of sublevel entries that is equal to the radix. Within this framework, patterns can be defined for specific languages and written or audio representations of numbers can be recreated.

Each level has a word recurrence value that denotes the number of recurring instances of the level, or the finest granularity to which the level applies. For example, Level 2 represents the hyphen or separator, which may vary with each number, i.e., there is a separator at “twenty-nine”, no separator at “thirty”, but a separator at “thirty-one”. Thus, the Level 2 word recurrence is 1.

Similarly, the Level 3 word recurrence is 10. Level 3 represents the tens digit of a number, and every instance of “twenty”, “thirty”, and so on are used ten times in succession.

In the example of Table 7, the levels of the first column do not necessarily correspond with the digits of a number to be represented. Level 1 in the example does correspond with the ones digit, however Level 2 corresponds with the hyphen and Level 3 corresponds with the tens digit.

In the embodiment of Table 7, the various levels are selected so that the highest number level corresponds with the first portion of the spoken or written representation. As will be shown later, the construction of the spoken or written representation begins with the highest layer and works down. In other embodiments, the layers may be arranged so that the lowest layer is the first to be processed.

In the current example, the sequence of Layer 3, Layer 2, and Layer 1 follows the natural representation of a number. For example, the representation of the number 53 would be “fifty-three”, with the “fifty” coming from the Layer 3 portion of Table 7, the hyphen “-” coming from the Layer 2 portion, and the “three” coming from the Layer 1 portion. If the current example were used to construct the representation of another language where the ones digit is spoken or written before the tens, Layer 3 may represent the ones digit and Layer 1 may represent the tens.

Because the representation framework of the embodiment is flexible, it may be used to represent the spoken or written representation of almost any language, regardless of the complexities of that language.

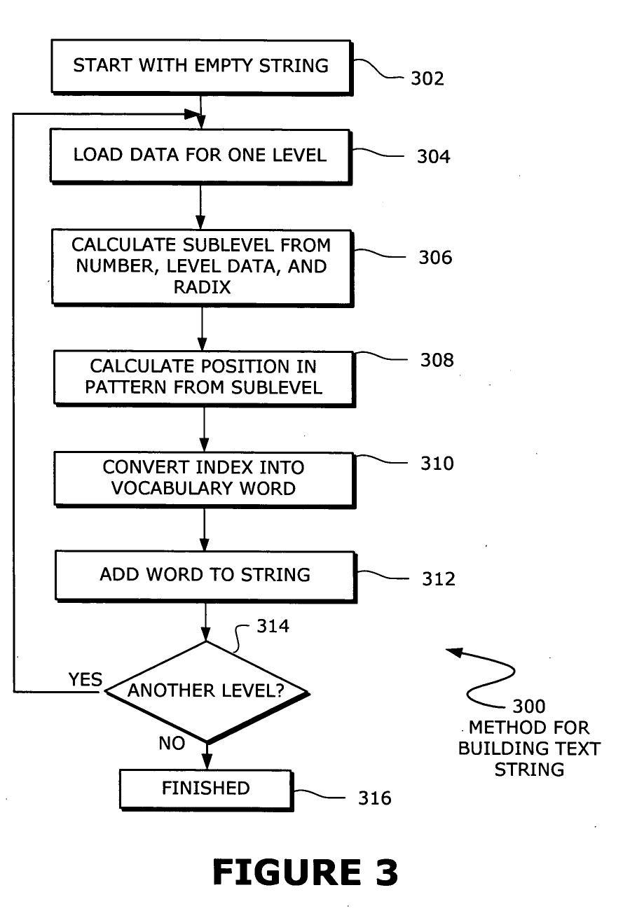

FIG. 3 illustrates an embodiment 300 of a method for building a text string using the database constructed from the method of embodiment 200. The process starts with an empty string in block 302. The data is loaded for the first level is loaded in block 304. The sublevel is calculated from the number, level data, and radix in block 306. The position within the pattern of the sublevel is calculated in block 308, from which an index is used to find the vocabulary word in block 310, which is added to the text string in block 312. If another level exists in block 314, the process continues at block 304 with the new level. If another level does not exist in block 314, the process ends in block 316 with the completed text string.

The embodiment 300 illustrates the construction of a textual representation of a number in a specific language. The same process may be used to construct a sequence of audio files or clips that are played in sequence to represent the number. For the purposes of this specification, anywhere a vocabulary word or text string is discussed, it shall be assumed that an audio file, audio clip, or any other audio representation of the number shall be able to be substituted, unless specifically excepted.

The embodiment 300 is a method to calculate the proper vocabulary word from the database constructed in embodiment 200. For each level, beginning from the highest, a sublevel value is calculated using the formula:

$$Sublevel = \frac{Number \% ( WordRecurrence * Radix )}{WordRecurrence} \qquad Equation 1$$

where Number is the number to be represented and WordRecurrence is taken from Table 7, column 2 for the appropriate level. The % operator or modulus, returns an integer remainder after dividing the first operand by the second. The division operator returns the truncated integer portion of the division operation, with no rounding.

Once the sublevel is calculated, the position within the sublevel pattern may be determined using the formula:

$$PositionInPattern = ( \frac{( \frac{Number}{WordRecurrence} )}{Radix} ) \% PatternCycle \qquad Equation 2$$

where PatternCycle is the number of recurring elements in the pattern. In general, the PatternCycle is usually, but not always, equal to the radix. As with the first equation, the % operator or modulus, returns an integer remainder after division and the division operator returns the integer portion of the division operation, with no rounding.

In a first example, the conversion of the number 45 to a text string will be shown.

The radix is 10, as this is the decimal system. In the example tables, the highest level is performed first, so Level 3 is selected. From Table 7 in the Level 3 section, the word recurrence value is 10. Using Equation 1, the sublevel is calculated as:

$$Sublevel = \frac{45 \% ( 10 * 10 )}{10} = 4$$

where 45% 100=45, and 45/10=4. Using Equation 2, the position in the pattern is:

$$PositionInPattern = ( \frac{( \frac{45}{10} )}{10} ) \%1 = 0$$

where 45/10=4, 4/10=0, and 4% 1=0. From column 4 of Table 7 in the Level 3 section, the pattern is index 1. From Table 6, the pattern is “0,0,0,0,0,0,0,0,0,0” and the vocabulary word is index 23. From Table 1, the first vocabulary word is “forty”.

Moving to Level 2 and examining Table 7 in the Level 2 section, the word recurrence value is 1. Using Equation 1 and number as 45, the sublevel is calculated as:

$$Sublevel = \frac{45 \% ( 1 * 10 )}{1} = 5$$

where 45% 10=5 and 5/1=5. Using Equation 2, the position in the pattern is:

$$PositionInPattern = ( \frac{( \frac{45}{1} )}{10} ) \%10 = 4$$

where 45/10=4 and 4% 10=4. From Table 6, the pattern is “0,0,1,1,1,1,1,1,1,1,” and the vocabulary indexes, from column 5 of Table 7, are 0, 20. At the fourth position of the pattern is index 1, which means that the second vocabulary index is required, in this case it is vocabulary index 20, or “-”, the hyphen. The hyphen is appended to the previous string, and the string becomes “forty-”.

Moving to Level 1 and examining Table 7 in the Level 1 section, the word recurrence value is 1. Again using Equation 1 and the number 45, the sublevel is calculated as:

$$Sublevel = \frac{45 \% ( 1 * 10 )}{1} = 5$$

where 45% 10=5 and 5/1=5. Using Equation 2, the position in the pattern is:

$$PositionInPattern = ( \frac{( \frac{45}{1} )}{10} ) \%10 = 4$$

where 45/10=4 and 4% 10=4. From Table 6, the pattern is “0,1,0,0,0,0,0,0,0,0”. The vocabulary indexes, from column 5 of Table 7 sublevel 5, are 5 and 15. The pattern indicates a “0” at the fourth position, indicating that the first vocabulary index should be used. Vocabulary index 5, from Table 1, is the string “five”, which is added to the previous string to yield “forty-five”.

In a second example, the number 19 will be converted into a text string.

The radix is 10, since it is a decimal representation. As in the previous example, Level 3 is selected first. From Table 7 in the Level 3 section, the word recurrence value is 10. Using Equation 1, the sublevel is calculated as:

$$Sublevel = \frac{19 \% ( 10 * 10 )}{10} = 1$$

where 19% 100=19, and 19/10=1. Using Equation 2, the position in the pattern is:

$$PositionInPattern ( \frac{( \frac{19}{10} )}{10} ) \%1 = 0$$

where 19/10=1, 1/10=0, and 0% 1=0. From column 4 of Table 7 in the Level 3 section, the pattern is index 1, with a vocabulary index of 0. From Table 6, the pattern is “0,0,0,0,0,0,0,0,0,0”. From Table 1, the first vocabulary word is “” or the empty string.

Moving to Level 2 and examining Table 7 in the Level 2 section, the word recurrence value is 1. Using Equation 1 and number as 19, the sublevel is calculated as:

$$Sublevel = \frac{19 \% ( 1 * 10 )}{1} = 9$$

where 19% 10=9 and 9/1=9. Using Equation 2, the position in the pattern is:

$$PositionInPattern = ( \frac{( \frac{19}{1} )}{10} ) \% 10 = 1$$

where 19/10=1 and 1% 10=1. From Table 6, the pattern is “0,0,1,1,1,1,1,1,1,1” and the vocabulary indexes, from column 5 of Table 7, are 0. At the second position of the pattern is index 0, which means that the first vocabulary index is required, in this case it is vocabulary index 0, or “”, the empty string. The null string is appended to the previous string, and the string remains the empty string.

Moving to Level 1 and examining Table 7 in the Level 1 section, the word recurrence value is 1. Again using Equation 1 and the number 19, the sublevel is calculated as:

$$Sublevel = \frac{19 \% ( 1 * 10 )}{1} = 9$$

where 19% 10=9 and 9/1=9, same as the previous level. Using Equation 2, the position in the pattern is:

$$PositionInPattern = ( \frac{( \frac{19}{1} )}{10} ) \% 10 = 1$$

where 19/10=1 and 1% 10=1, same as the previous level. From Table 6, the pattern is “0,1,0,0,0,0,0,0,0,0”. The vocabulary indexes, from column 5 of Table 7 sublevel 9, are 9 and 19. The pattern indicates a “1” at the second position (using a zero-based indexing system), indicating that the second vocabulary index should be used. Vocabulary index 5, from Table 1, is the string “nineteen”, which is added to the previous empty string to yield “nineteen”.

The two previous examples illustrate how the database, as constructed by the method of embodiment 200, may be used to generate a specific sequence of text strings that represent numbers. Databases may be constructed for many different languages or representations of numbers, such as Italian, Spanish, Arabic, Hebrew, Japanese, Chinese, Roman Numerals, or any other representation of a number that may be constructed from a sequenced vocabulary. Further, the database embodied in the various Tables maybe expanded to include hundreds, thousands, millions, etc.

Many different variations of the database construction may be used. For example, in some databases, the hyphen separator may be handled by creating vocabulary words that incorporate the hyphen in the text string. By making the patterns and tables accordingly, the hyphen separator of Level 2 of the above example may be removed. When the various databases use consistent syntax, the method of embodiment 300 will construct the representation of any number.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method comprising:
determining a first vocabulary for numbers to be represented, said first vocabulary being from a first language;
creating a plurality of levels for repeated words of said first vocabulary, each of said levels being assigned a word recurrence value;
for each of said plurality of levels, creating a number of sublevel entries equal to a first radix for said language; and
mapping said first vocabulary to said sublevel entries.

2. The method of claim 1 further comprising:
receiving a number to be represented as a series of vocabulary entries;
determining a starting level; and
for each level, perform a method comprising:
calculate a sublevel;
calculate a position within said sublevel;
finding a pattern for said position within said sublevel;
determine an index from said pattern;
determine a vocabulary word from said index; and
adding said vocabulary word to said series of vocabulary entries.

3. The method of claim 2 wherein said vocabulary entries comprises text strings.

4. The method of claim 2 wherein said vocabulary entries comprises audio files.

5. The method of claim 1 wherein said radix is 10.

6. The method of claim 1 wherein said first vocabulary comprises English language words.

7. The method of claim 1 further comprising:
determining a second vocabulary for numbers to be represented, said second vocabulary being from a second language;
determining a radix for said numbers;
determining a first radix for said language;
creating a plurality of levels for repeated words of said second vocabulary, each of said levels being assigned a word recurrence value;
for each of said plurality of levels, creating a number of sublevel entries equal to said radix; and
mapping said second vocabulary to said sublevel entries.

8. A method comprising:
receiving a number to be represented;
referencing a database comprising:
a first vocabulary for numbers to be represented, said first vocabulary being from a first language;
a first radix for said first language;
a plurality of levels for repeated words of said first vocabulary, each of said levels being assigned a word recurrence value;
for each of said plurality of levels, a number of sublevel entries equal to said radix multiplied by a first positive integer, wherein said first vocabulary is mapped to said sublevel entries;
determining a starting level; and
for each level, perform a method using said database comprising:
calculate a sublevel;
calculate a position within said sublevel;
finding a pattern for said position within said sublevel;
determine an index from said pattern;
determine a vocabulary word from said index; and
adding said vocabulary word to a series of vocabulary entries.

9. The method of claim 8 wherein said series of vocabulary entries comprises text strings.

10. The method of claim 8 wherein said series of vocabulary entries comprises audio files.

11. The method of claim 8 wherein said radix is 10.

12. The method of claim 8 wherein said vocabulary comprises English language words.

13. The method of claim 8 wherein:
said database further comprises:
a second vocabulary for numbers to be represented, said second vocabulary being from a second language;
a first radix for said second language;
a plurality of levels for repeated words of said second vocabulary, each of said levels being assigned a word recurrence value; and
for each of said plurality of levels, a number of sublevel entries equal to said radix, wherein said second vocabulary is mapped to said sublevel entries; and
said method comprises selecting one of said first language or said second language.

14. A computer readable medium comprising computer-executable instructions for performing the method recited in claim 8.

15. A system comprising:
a database comprising:
a first vocabulary for numbers to be represented, said first vocabulary being from a first language;
a first radix for said first language;
a plurality of levels for repeated words of said first vocabulary, each of said levels being assigned a word recurrence value;
for each of said plurality of levels, a number of sublevel entries equal to said radix multiplied by a positive integer, wherein said first vocabulary is mapped to said sublevel entries;
a first computer application in communication with said database and adapted to perform the method comprising receiving a number to be represented as series of vocabulary entries, determining a starting level, and for each level, perform a method using said database comprising:
calculate a sublevel;
calculate a position within said sublevel;
finding a pattern for said position within said sublevel
determine an index from said pattern;
determine a vocabulary word from said index; and
adding said vocabulary word to said series of vocabulary entries.

16. The system of claim 15 wherein said database comprises multiple languages.

17. The system of claim 15 wherein said series of vocabulary entries comprises a text string.

18. The system of claim 15 wherein said series of vocabulary entries comprises an audio file.

19. The system of claim 15 further comprising a second computer application in communication with said database and adapted to perform the method comprising receiving a number to be represented as a text string, determining a starting level, and for each level, perform a method using said database comprising:
calculate a sublevel;
calculate a position within said sublevel;
finding a pattern for said position within said sublevel
determine an index from said pattern;
determine a vocabulary word from said index; and
adding said vocabulary word to said text string.

20. The system of claim 15 wherein:
said database further comprises:
a second vocabulary for numbers to be represented, said second vocabulary being from a second language;
a first radix for said second language;
a plurality of levels for repeated words of said second vocabulary, each of said levels being assigned a word recurrence value; and
for each of said plurality of levels, a number of sublevel entries equal to said radix, wherein said second vocabulary is mapped to said sublevel entries; and
said first computer application is further adapted to select one of said first language or said second language.
